(19) United States
(12) Patent Application Publication
(10) Pub. No.: US 2007/0154251 A1
(43) Pub. Date: Jul. 5, 2007

(54) Labeling article including a stack of labels, sheet feeding cassette to which label is attached and image forming apparatus equipped with sheet feeding cassette

(75) Inventor: Tadasu Taniguchi, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/638,461

(22) Filed: Dec. 14, 2006

(30) Foreign Application Priority Data
Jan. 5, 2006 (JP) 2006-000857

(51) Int. Cl. B41J 13/10; B41J 13/12

(52) U.S. Cl. 400/624

(57) ABSTRACT

A labeling article including a stack of labels, each label having a front face on which at least one of a size and a type of a printing sheet to be contained in a sheet feeding cassette is written, and a back face provided with an adhesive part on which a pressure-sensitive adhesive is applied, wherein the stack is so formed that the labels are overlaid sequentially such that the adhesive part of one label adheres to another label, and each label is adapted to be separated from the stack and to be attached to the sheet feeding cassette.

### CROSS-REFERENCE TO RELATED APPLICATION

This application is related to Japanese patent application No. 2006-857 filed on Jan. 5, 2006 whose priority is claimed under 35 USC §119, the disclosure of which is incorporated by reference in its entirety.

### BACKGROUND OF THE INVENTION

1. Field of the Invention

The present invention relates to a labeling article including a stack of labels, and a sheet feeding cassette to which the label is attached. Further, the present invention relates to an image forming apparatus equipped with the sheet feeding cassette.

2. Description of Related Art

In an image forming apparatus, sheet feeding cassettes for various printing sheet sizes and types are usually installed as standard equipment. Further, in order to deal with multiple types of printing sheet, there is one to which a sheet feeding cassette can be added optionally, besides the sheet feeding cassettes installed as standard equipment. In many image forming apparatuses of recent years, sheet feeding cassettes of a drawer type are arranged to be stacked under an image forming section in order to make the occupying space of the apparatus compact. The mechanism of sheet feeding cassettes configured in this manner is called a “front access mechanism” or a “built-up method”. In such a apparatus, a sheet path for transporting a printing sheet, fed from each sheet feeding cassette, to the image forming section is provided in a vertical direction, and the respective sheet feeding cassettes are arranged in an up and down direction along the sheet path.

Many sheet feeding cassettes, added optionally, can change the size of a printing sheet to be contained therein as required by a user (universal cassettes). This is because wide ranging sizes of printing sheet are to be used depending on users. Such user installs the required number of universal cassettes into an image forming apparatus corresponding to the sizes and/or types of printing sheet to be used. Namely, when the number of sheet feeding cassettes having been installed in the apparatus as standard equipment is not enough, the user obtains optional universal cassettes additionally, and installs them into vacant slots. The installed universal cassettes have the same outer appearance, so they are not distinguishable from each other. In some apparatuses, they are not distinguishable from the sheet feeding cassettes installed as standard equipment.

As described above, when a plurality of sheet feeding cassettes having the same outer appearance are installed in a apparatus, it is required that a user can identify the size and type of printing sheets contained in each sheet feeding cassette for supplying printing sheets in the sheet feeding cassette.

To realize this, a method has been known in which an information card with printing sheet sizes written thereon is folded so as to expose the required size on its front face, and is placed at the size indicating window provided on an exterior part of a sheet feeding cassette thereby indicating the size of the printing sheet contained in the sheet feeding cassette (see, for example, Japanese Examined Patent Publication No. 3661672).

Allocation of the size and/or type to each sheet feeding cassette is determined by a user. Accordingly, an operation to display the allocated size and/or type on the exterior part of each sheet feeding cassette is carried out by the user.

Note that the size and/or type of printing sheet allocated to each sheet feeding cassette is a size and/or type that a user often uses, so it is unlikely that the allocation is to be changed frequently. Particularly, when a user additionally installs the required number of sheet feeding cassettes, it may be true. Many image forming apparatuses have manual sheet feeding trays besides sheet feeding cassettes. Particularly, in an apparatus having a manual sheet feeding tray, it is expected that a manual sheet feeding tray will be used for a printing sheet of a size and/or type rarely used. Accordingly, it is reasonable to put more emphasis on the cost or on operability and convenience of a user to indicate the initially allocated size and/or type, rather than considering operability and convenience in changing the initially allocated indications.

### SUMMARY OF THE INVENTION

The present invention has been developed considering the situations described above. The present invention is directed to providing a labeling article including a labels, each label being used for indicating a size and/or type of printing sheets to be contained in a sheet feeding cassette, the article having an inexpensive simple configuration and being used with an easy operation, and is directed to provide a sheet feeding cassette on which the label is attached.

The present invention provides a labeling article including a stack of labels, each label having a front face on which at least one of a size and a type of a printing sheet to be contained in a sheet feeding cassette is written, and a back face provided with an adhesive part on which a pressure-sensitive adhesive is applied, wherein the stack is so formed that the labels are overlaid sequentially such that the adhesive part of one label adheres to another label, and each label is adapted to be separated from the stack and to be attached to the sheet feeding cassette.

Further, the present invention provides a sheet feeding cassette adapted to be installed into an image forming apparatus and having an exterior part, wherein the exterior part has an attachment area for attachment of any of the labels of the above mentioned labeling article.

Moreover, the present invention provides an image forming apparatus including the above mentioned sheet feeding cassette.

### BRIEF DESCRIPTION OF THE DRAWINGS

FIG. 1 is an illustration showing front faces of a plurality of labels held by a labeling article according to the present invention;

FIG. 2 is an illustration showing a state of adhesive part provided on the back face of each sheet in FIG. 1;

FIG. 3 is a perspective view showing the labeling article consisting of the respective labels 1a to 1f, shown in FIGS. 1 and 2, overlaid on a mount;

FIG. 4 is a perspective view in schematic form showing the exterior part of a sheet feeding cassette to which the label of the present invention is to be attached; and

FIG. 5 is an illustration showing the outer appearance of an image forming apparatus into which the sheet feeding cassette according to the present invention is installed.

### DETAILED DESRIPTION OF THE PREFERRED EMBODIMENTS

Since the labeling article of the present invention includes a stack of labels, the labels can be provided to a user in an integrated manner. By selecting the appropriate label among the labeling article and attaching the label to the sheet feeding cassette, the user can easily indicate the size and/or type of printing sheet contained in the sheet feeding cassette. In this case, the user is only necessary to carry out a simple operation to separate the front face of the selected label from other labels to expose the written size and/or type, and to separate other labels so as to expose the adhesive part of the selected label, and to attach the selected label to the exterior part of the sheet feeding cassette. With such a simple operation, i.e. without bothering the user, it is possible to indicate the size and/or type of printing sheet contained in the sheet feeding cassette. Further, both the labeling article of the present invention and the exterior part of the sheet feeding cassette to which the label adheres has an inexpensive simple configuration.

The adhesive part may be formed on a part of the back face. With this configuration, a user can easily separate other labels overlaid on the selected label. Further, when a user attaches a wrong label by mistake or changes the size of printing sheet to be contained in the sheet feeding cassette, the user can easily peel off the attached label.

Further, each label may be to be attached to a substantially vertical surface of the sheet feeding cassette, and the adhesive part may be formed on at least a part of the back face near a top edge thereof. With this configuration, since a part near the top edge of the label adheres to a sheet feeding cassette, the label is unlikely to be peeled off due to its own weight.

A base material of the labels may be polyethylene terephthalate. By using a resin film made of polyethylene terephthalate (PET), the label is less likely to be torn compared with a material such as bond paper, and is less subject to stain. However, the base material of the label is not limited to the above-mentioned material. It may be polyvinyl chloride (PVC), or one in which a transparent resin film such as polypropylene (PP) is attached on a printing sheet, for example.

The adhesive part may be a part on which a pressure-sensitive adhesive having adhesion is applied which enables separation from other labels without damaging the front face of the opposite label overlaid thereon, and in which, after separation, the label can be fixed to the exterior part of the sheet feeding cassette with the adhesion of the adhesive part. As such a pressure-sensitive adhesive, a well-known adhesive used for a so-called self adhesive seals and stickers can be applied. For the pressure-sensitive adhesive used for these purposes, one in which a plasticizing agent, adhesive applying resin or silicone compound is mixed in acrylic resin is well-known. Further, one using natural rubber or synthetic rubber, instead of acrylic resin, is also known.

The pressure-sensitive adhesive may be a repeeling type of adhesive. With this configuration, the label can be peeled off from another label overlaid thereon. Further, the label attached by mistake can be peeled off cleanly, or if the size of printing sheet contained in the sheet feeding cassette is changed, the label can be peeled off cleanly so as to be replaced.

Further, the attachment area of the sheet feeding cassette may have a smoother finish than the rest of the exterior part. With this configuration, since the area to which the label is attached is finished smoothly, a strong adhesive force is caused, so the label is unlikely to be peeled off.

The sheet feeding cassette may be adapted to accommodate a change in a size of a printing sheet to be contained therein.

Hereinafter, the present invention will be explained in detail by using the drawings. The present invention will be more clearly understood from the following description. Note that the below description should be considered as examples, not limitations, in all aspects.

FIG. 1 is an illustration showing the front faces of a plurality of labels held by a labeling article according to the present invention. In FIG. 1, on the front face of each label, a size is written. On the front face of a label 1a, “A4 Portrait” is written as a printing sheet size, and “B4” is written on the front face of a label 1b, “Postcard” is written on the front face of a label 1c, “A4 Landscape” is written on the front face of a label 1d, “B5” is written on the front face of a label 1e, and “A3” is written on the front face of a label 1f, as printing sheet sizes, respectively. The material of the label may be paper, but resin such as polyethylene terephthalate, for example, may also be used.

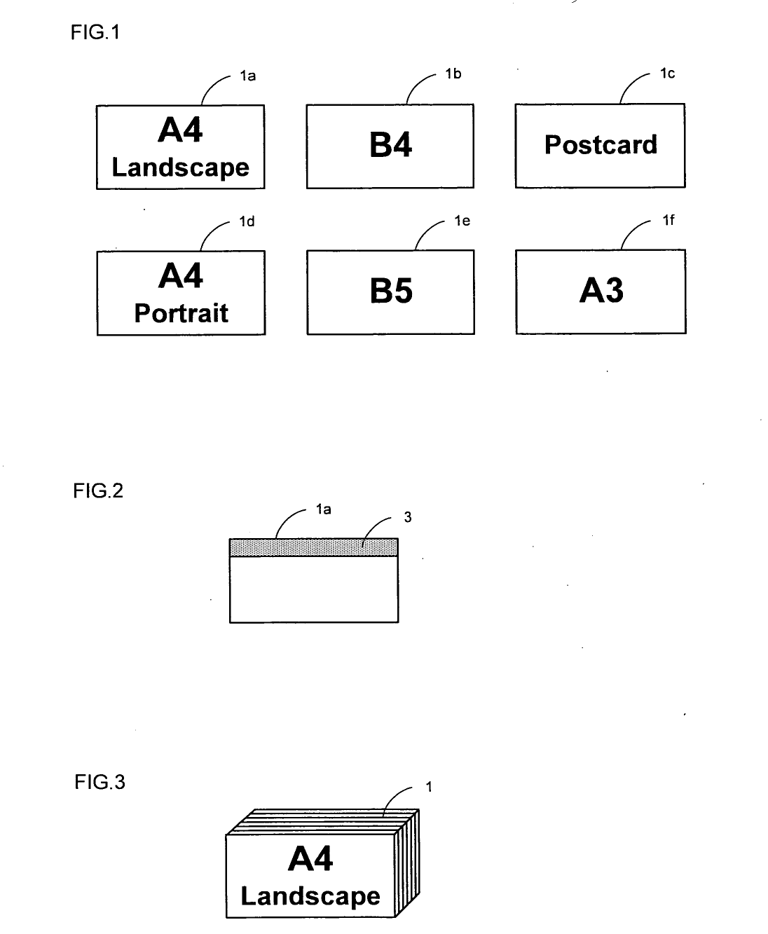

FIG. 2 is an illustration showing the state of an adhesive part provided on the back face of each label shown in FIG. 1. In FIG. 2, the label 1a is shown as a representative, but this also applies to other labels. As shown in FIG. 2, the adhesive part 3 is applied with a pressure-sensitive adhesive on the upper edge part.

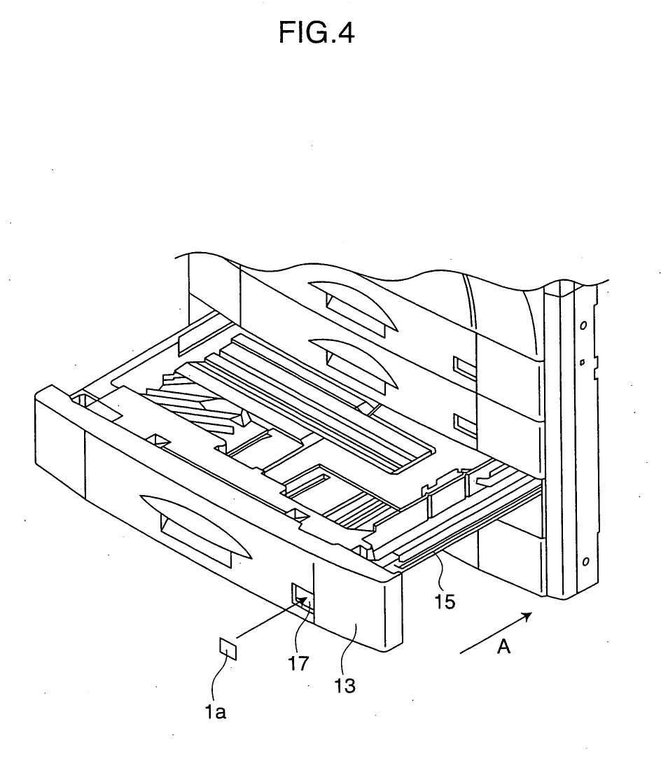

FIG. 3 is a perspective view showing a labeling article formed by the respective labels 1a to 1f shown in FIGS. 1 and 2 overlaid on a mount not shown in FIG. 1. As shown in FIG. 3, the top face of the labeling article 1 is the label 1a on which “A4 Portrait” is written. The bottom face is the mount, and the labels 1b to 1f are overlaid between the both. The respective labels 1a to 1f and the mount are integrated with the adhesive property of the adhesive parts 3.

A universal cassette is supplied with the labeling article 1 shown in FIG. 3. A user determines the size and/or type of printing sheet to be contained in the universal cassette, and installs it to the image forming apparatus.

Then, the user peels off the labels overlaid on the front face side of a desired label on which the determined size and/or type are/is written to thereby exposing the size and/or type. Of course, if the desired label is the top face of the labeling article 1, there is no need to peel off unnecessary labels. Further, the user peels off the labels overlaid on the back face side of the desired label to thereby expose the adhesive part on the back face of the desired label. Then, the user attaches the exposed adhesive part to the exterior part of the universal cassette so that the size and/or type are/is indicated.

When a plurality of universal cassettes are additionally installed and different sizes and/or types of printing sheet are contained in the respective cassettes, labels included in the labeling article 1 may be attached to the exterior parts of the respective cassettes. In this way, the number of labels, which will not be used and will be discarded, can be reduced. This is applicable to a peripheral device (called as a sheet feeding desk) accommodating multiple stages of sheet feeding cassettes for example.

Although only one label is attached to the exterior part in the description above, the usage is not limited to this configuration. A user may peel off unnecessary labels overlaid on the front face side of the label on which the determined size and/or type are/is written to thereby expose the size and/or type, and then, peel off the mount of the bottom face from the label overlaid thereon, to thereby attach the adhesive part of the label, which was overlaid on the mount, to the exterior part of the cassette. In this case, it is attached to the exterior part in a state where multiple pieces of labels are overlaid.

Further, a user may peel off unnecessary labels overlaid on the front face side of the label on which the determined size and/or type are/is written to thereby expose the size and/or type, and further, peel off the mount of the bottom face from the labels mounted thereof, and attach the front face of the peeled unnecessary labels to the adhesive part peeled from the mount, and attach the multiple labels attached together to the exterior part of the cassette. In this way, the labels attached to the exterior part can be used even when the size and/or type of the sheet feeding cassette is changed in the future.

FIG. 4 is a perspective view showing the overview of a sheet feeding cassette to which the labeling article of the present invention is to be attached. As shown in FIG. 4, the sheet feeding cassette 11 has a guide rail 15 so as to be able to slide in a direction of the arrow A, and is installed into a slot of the body. On the front side of the cassette 11, an exterior 13 is mounted. In a state where the sheet feeding cassette 11 is accommodated in the body, the front side of the exterior 13 is exposed.

An exemplary material of the exterior 13 is ABS resin. The surface of ABS resin has fine irregularities for enhancing the design value. That is, so-called embossing is performed. The adhesion area to which a desired label, the label 1a in FIG.4, is attached has a smooth surface without embossing so as to have a strong adhesive force when the labeling article 1 is attached.

According to the present invention, since the labeling article 1 is fixed to the exterior 13, complicated configuration and shape are not required, which is advantageous from the viewpoint of cost.

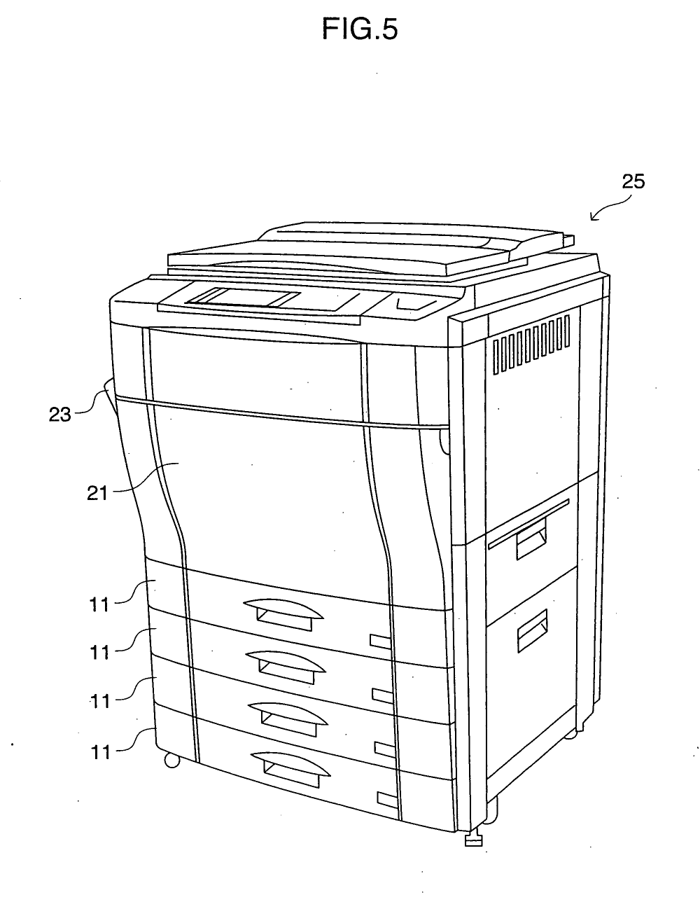

FIG. 5 is an illustration showing the outer appearance of an image forming apparatus 20 into which sheet feeding cassettes according to the present invention are installed. As shown in FIG. 5, a plurality of sheet feeding cassettes 11 are arranged under the image forming section 21 so as to be stacked in up and down. Here, the image forming section 21 is a section for forming an image to be printed, and transferring the formed image onto a printing sheet fed from the sheet feeding cassette 11, and ejecting it onto a catch tray 23.

Finally, it is obvious that various deformations can be made for the present invention besides the embodiment described above. Such deformations should not be construed as not belonging to the characteristics and the scope of the present invention. It is intended that the scope of the present invention includes all modifications within the meaning and the scope equivalent to the scope of the claims.

1. A labeling article comprising a stack of labels, each label having a front face on which at least one of a size and a type of a printing sheet to be contained in a sheet feeding cassette is written, and a back face provided with an adhesive part on which a pressure-sensitive adhesive is applied, wherein
the stack is so formed that the labels are overlaid sequentially such that the adhesive part of one label adheres to another label, and
each label is adapted to be separated from the stack and to be attached to the sheet feeding cassette.

2. The article according to claim 1, wherein the adhesive part is formed on a part of the back face.

3. The article according to claim 1, wherein each label is to be attached to a substantially vertical surface of the sheet feeding cassette, and the adhesive part is formed on at least a part of the back face near a top edge thereof.

4. The article according to claim 1, wherein a base material of the labels is polyethylene terephthalate.

5. The article according to claim 1, wherein the pressure-sensitive adhesive is a repeeling type of adhesive.

6. A sheet feeding cassette adapted to be installed into an image forming apparatus and having an exterior part, wherein
the exterior part has an attachment area for attachment of any of the labels of the labeling article according to claim 1.

7. The sheet feeding cassette according to claim 6, wherein the attachment area has a smoother finish than the rest of the exterior part.

8. The sheet feeding cassette according to claim 6, adapted to accommodate a change in a size of a printing sheet to be contained therein.

9. An image forming apparatus comprising a sheet feeding cassette according to claim 6.

10. An image forming apparatus comprising a sheet feeding cassette according to claim 7.

11. An image forming apparatus comprising a sheet feeding cassette according to claim 8.
